(19) United States
(12) Patent Application Publication
(10) Pub. No.: US 2026/0362492 A1
(43) Pub. Date: Nov. 12, 2026

(54) Method and Apparatus for PRACH Resource and Tracking Reference Signal Adaptation in Wireless Communication

(71) Applicant: Apple Inc., Cupertino, CA (US)

(72) Inventors: Hong HE, San Jose, CA (US); Dawei ZHANG, Saratoga, CA (US); Wei ZENG, Saratoga, CA (US); Huaning NIU, San Jose, CA (US); Chunhai YAO, Beijing (CN); Ankit BHAMRI, Haar (DE); Jie CUI, San Jose, CA (US)

(21) Appl. No.: 19/103,097

(22) PCT Filed: Aug. 11, 2023
(86) PCT No.: PCT/US2023/030047

§ 371 Date: Feb. 11, 2025

Related U.S. Application Data
(60) Provisional application No. 63/371,100, filed on Aug. 11, 2022.

(51) Int. Cl. H04W 74/0833; H04W 52/02; H04W 72/232

(52) U.S. Cl. CPC H04W 74/0833; H04W 52/0235; H04W 72/232

(57) ABSTRACT

A user equipment (UE) configured to decode, based on signaling received from a base station, a system information block (SIB) comprising a set of physical random access channel (PRACH) configurations for when the base station is to utilize a power saving mode and determine one of the PRACH configurations from the set of PRACH configurations is to be utilized for a random access channel (RACH) procedure.

### PRIORITY/INCORPORATION BY REFERENCE

This application claims priority to U.S. Provisional Application Ser. No. 63/371,100 filed on Aug. 11, 2022, and entitled “Method and Apparatus for PRACH Resource and Tracking Reference Signal Adaptation in Wireless Communication,” the entirety of which is incorporated herein by reference.

### BACKGROUND

Typically, energy saving mechanisms are designed to conserve power at a user equipment (UE). However, energy consumption is also a concern on the network side and network power saving mechanisms may also be utilized. It has been identified that there is a need for techniques configured to support the implementation of network power saving mechanisms.

### SUMMARY

Some exemplary embodiments are related to an apparatus of a user equipment (UE), the apparatus having processing circuitry configured to decode, based on signaling received from a base station, a system information block (SIB) comprising a set of physical random access channel (PRACH) configurations for when the base station is to utilize a power saving mode and determine one of the PRACH configurations from the set of PRACH configurations is to be utilized for a random access channel (RACH) procedure.

Other exemplary embodiments are related to a processor configured to decode, based on signaling received from a base station, a system information block (SIB) comprising a set of physical random access channel (PRACH) configurations for when the base station is to utilize a power saving mode and determine one of the PRACH configurations from the set of PRACH configurations is to be utilized for a random access channel (RACH) procedure.

Still further exemplary embodiments are related to an apparatus of a base station, the apparatus having processing circuitry configured to configure transceiver circuitry to transmit a system information block (SIB) comprising a set of physical random access channel (PRACH) configurations for when the base station is to utilize a power saving mode and configure transceiver circuitry to transmit downlink control information (DCI) to a user equipment (UE), the DCI indicating one PRACH configuration from the set of PRACH configurations is to be utilized for a random access channel (RACH) procedure.

Additional exemplary embodiments are related to a processor configured to configure transceiver circuitry to transmit a system information block (SIB) comprising a set of physical random access channel (PRACH) configurations for when the base station is to utilize a power saving mode and configure transceiver circuitry to transmit downlink control information (DCI) to a user equipment (UE), the DCI indicating one PRACH configuration from the set of PRACH configurations is to be utilized for a random access channel (RACH) procedure.

Exemplary embodiments are also related to an apparatus of a user equipment (UE), the apparatus having processing circuitry configured to decode, from signaling received from a base station, a signal comprising multiple tracking reference signal (TRS) resource sets for when the base station is to utilize a power saving mode and decode, from signaling received from the base station, downlink control information (DCI) indicating whether zero or more of the multiple TRS resources sets are to be activated for the power saving mode.

More exemplary embodiments are related to a processor configured to decode, from signaling received from a base station, a signal comprising multiple tracking reference signal (TRS) resource sets for when the base station is to utilize a power saving mode and decode, from signaling received from the base station, downlink control information (DCI) indicating whether zero or more of the multiple TRS resources sets are to be activated for the power saving mode.

Further exemplary embodiments are related to an apparatus of a base station, the apparatus having processing circuitry configured to configure transceiver circuitry to transmit a signal to a user equipment (UE) comprising multiple tracking reference signal (TRS) resource sets for when the base station is to utilize a power saving mode and configure transceiver circuitry to transmit downlink control information (DCI) indicating whether zero or more of the multiple TRS resources sets are to be activated for the power saving mode.

Still more exemplary embodiments are related to a processor configured to configure transceiver circuitry to transmit a signal to a user equipment (UE) comprising multiple tracking reference signal (TRS) resource sets for when the base station is to utilize a power saving mode and configure transceiver circuitry to transmit downlink control information (DCI) indicating whether zero or more of the multiple TRS resources sets are to be activated for the power saving mode.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for dynamic adaptation of PRACH resources according to various exemplary embodiments.

FIG. 5 shows an example abstract syntax notation one (ASN.1) according to various exemplary embodiments.

FIG. 6 shows a table according to various exemplary embodiments.

FIG. 7 shows a method for dynamic adaptation of physical random access channel (PRACH) resources according to various exemplary embodiments.

FIG. 8 shows an example of DCI according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques configured to support the implementation of network power saving mechanisms.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The exemplary embodiments are further described with regard to a network power saving mode (PSM). Throughout this description, the term “PSM” may be used to refer to a time interval during which the gNB utilizes a sleep mode to conserve power. Reference to PSM or a sleep mode does not necessarily mean putting processing components, transmitting components and/or receiving components for a cell operated by the gNB to sleep, in hibernation, or in deactivation. Instead, the PSM described herein relates to conserving power by discontinuing at least a subset of data exchange processing functionality associated with operating as a base station. Outside of the PSM, the gNB may use an active mode of data exchange processing to transmit and/or receive the traffic that is not exchanged during the PSM. However, reference to the term “PSM” is merely provided for illustrative purposes, different entities may refer to a similar concept by a different name.

The following non-limiting examples describe some types of operations that may be discontinued during the PSM. The gNB may discontinue transmitting physical downlink shared channel (PDSCH), the gNB may discontinue transmitting periodic tracking reference signals (TRS), the gNB may discontinue receiving physical uplink shared channel (PUSCH) and the gNB may discontinue transmitting and receiving various different types of periodic/semi-persistent (SP) signals (e.g., synchronization signal blocks (SSBs), physical random access channel (PRACH) resources, periodic channel state information (CSI) reports, periodic CSI-reference signals (RS), semi-persistent (SP) CSI-RS, periodic sounding reference signals (SRS), SP SRS, etc. ).

When the gNB is in the PSM, the UE may be configured to discontinue or omit various different types of operations.

That is, the UE may adapt its behavior to the PSM of the gNB to ensure that the UE does not perform operations to transmit a signal that will not actually be received by the gNB due to PSM or operations to receive a signal that will not actually be transmitted by the gNB due to PSM.

The following non-limiting examples describe exemplary UE behavior while the gNB is in PSM. The UE may discontinue transmitting PRACH resources during a random access channel (RACH) occasion, the UE may not attempt to measure CSI-RS resources (e.g., periodic CSI-RS, SP CSI-RS, TRS), the UE may discontinue beam failure detection measurements, the UE may discontinue beam failure recovery measurements, the UE may discontinue reporting periodic/SP/aperiodic (AP) CSI on and for a serving cell, the UE may discontinue transmitting configured grant PUSCH, the UE may discontinue monitoring physical downlink control channel (PDCCH) on and for a serving cell, the UE may discontinue transmitting PUCCH on the serving cell (including scheduling request (SR) physical uplink control channel (PUCCH) transmission), the UE may discontinue transmitting periodic/SP SRS on the serving cell and the UE may not receive SSB. However, these examples are provided for illustrative purposes, the UE behavior may adapt to the PSM configuration. The exemplary embodiments do not require that the UE behave in any particular manner during PSM.

According to some aspects, the exemplary embodiments introduce techniques for dynamic adaptation of PRACH resources for network power saving. As will be described in more detail below, the exemplary embodiments may notify the UE as to which PRACH configuration is to be utilized during PSM. The exemplary embodiments may be utilized independently from one another, in conjunction with other currently implemented network power saving techniques, in conjunction with future implementations of network power saving techniques or independently from other network power saving techniques.

According to other aspects, the exemplary embodiments introduce techniques for dynamic adaptation of periodic TRS resource sets for network power saving. As will be described in more detail below, the exemplary embodiments may notify the UE of as to which TRS resource set is to be utilized during PSM. The exemplary embodiments may be utilized independently from one another, in conjunction with other currently implemented network power saving techniques, in conjunction with future implementations of network power saving techniques or independently from other network power saving techniques.

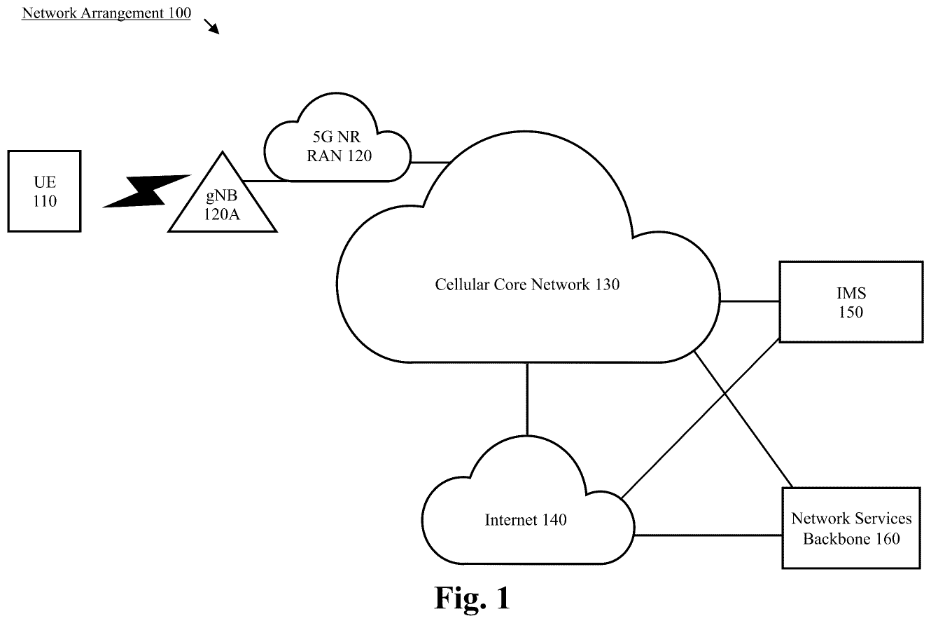

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc. ) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

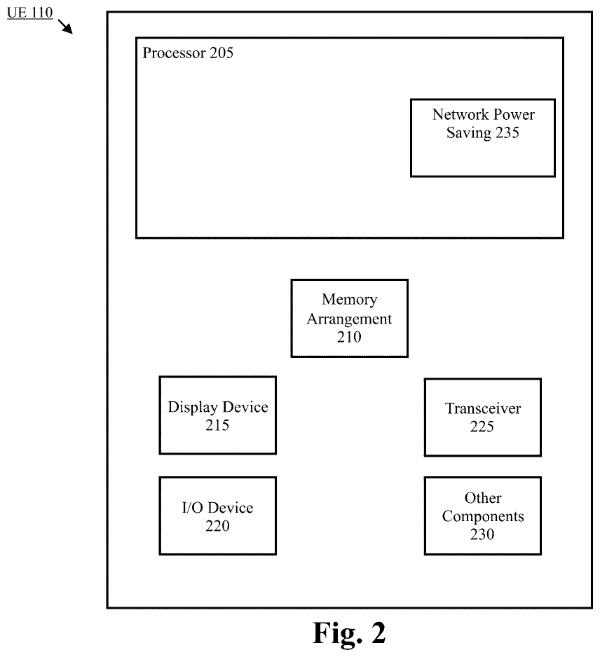

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a network power saving engine 235. The network power saving engine 235 may perform various operations related network power saving such as, but not limited to, receiving configuration information related to PSM operation, receiving downlink control information (DCI) and adapting the UE 110 behavior to the PSM operation.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

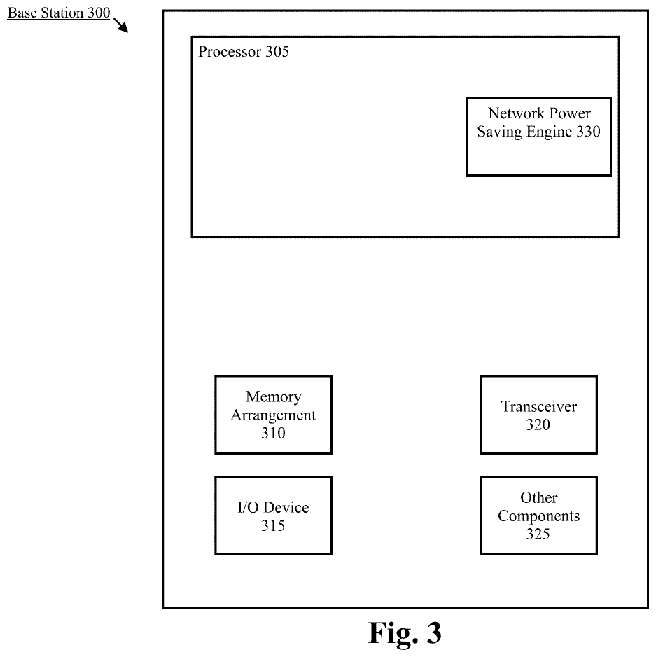

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the network power saving engine 330 may perform various operations related network power saving such as, but not limited to, transmitting PSM configuration information, transmitting DCI and switching on and off PSM.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

According to some aspects, the exemplary embodiments introduce techniques for dynamic adaptation of PRACH resources for network power saving. As will be described in more detail below, the exemplary embodiments may enable fast RACH adaptation without the need for a system information update.

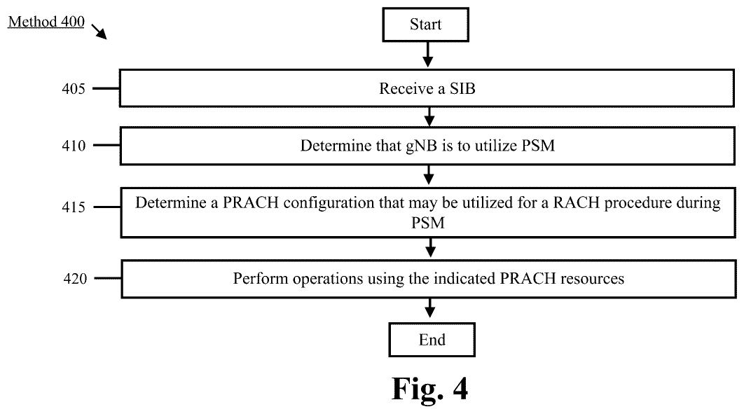

FIG. 4 shows a method 400 for dynamic adaptation of PRACH resources according to various exemplary embodiments. The method 400 is described from the perspective of the UE 110.

In 405, the UE 110 receives a SIB. The SIB may include information that enables the UE 110 to subsequently perform dynamic PRACH resource adaptation. For example, the SIB may include a list of PRACH configurations that may be utilized by the UE 110 when the gNB 120A is in PSM.

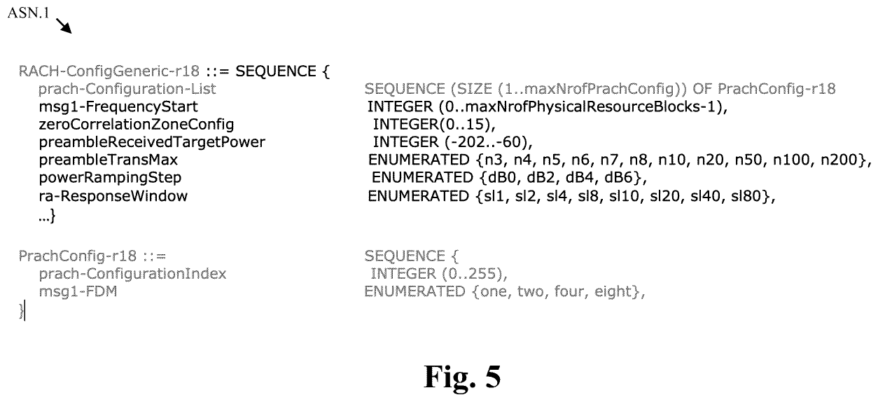

In some embodiments, the SIB may be a SIB1 with a RACH-ConfigGeneric IE enhanced to support a prach-ConfigurationIndex and a list of message 1 (msg1)-frequency division multiplexing (FDM) IEs. An example abstract syntax notation one (ASN.1) 500 for these exemplary IEs are shown in FIG. 5. The exemplary ASN.1 shows a “RACH-ConfigGeneric-release 18(r18 )” IE configured to include a prach-Configuration-List parameter corresponding to a PRACHConfig-r18 IE. The exemplary PRACHConfig-r18 IE includes a prach-ConfigurationIndex parameter and a msg1-FDM parameter. However, reference to SIB1 and the exemplary IEs reference above are not intended to limit the exemplary embodiments in any way. The UE 110 may receive information related to dynamic PRACH resource adaptation operation in any appropriate manner.

In 410, the UE 110 determines when the gNB 120A is to utilize PSM. For example, the UE 110 may receive a signal from the gNB 120A indicating that a particular PSM cycle or pattern is to be utilized by the gNB 120A. In another example, the UE 110 may implicitly determine that the gNB 120A has entered PSM.

In 415, the UE 110 determines a PRACH configuration that may be utilized for a RACH procedure during the PSM. Those skilled in the art will understand that the PRACH configuration may indicate to the UE 110 parameters such as when the UE 110 is permitted to transmit PRACH resources and which kind of PRACH preamble should be transmitted. For instance, the PRACH configuration index may indicate to the UE 110 which frame number and which subframe number (SFN) within the frame has PRACH resources, a preamble format (e.g., 1, 2, 3, A1, A2, B2, A3,B4, C0, C1, C2, etc.), a periodicity and/or any other appropriate type of parameter.

The PRACH configuration may be dynamically indicated to the UE 110 by a PRACH indication field (PIF) in DCI. In some embodiments, the bitwidth of the PIF may be represented as [log₂(N)] where N represents a number of entries in the prach-configuration-list provided in 405.

The exemplary embodiments introduce a new DCI format that may be used to provide this type of information. Throughout this description, this DCI format may be referred to as “DCI format 2_Y.” In some embodiments, the DCI format 2_Y include CRC bits scrambled with a dedicated RNTI provided to idle mode UES via a SIB. Instead of being provided via SIB, the RNTI for DCI format 2_Y may be hard encoded in the 3GPP Specifications or provided in any other appropriate manner. However, reference to DCI format 2_Y is merely provided for illustrative purposes, the 2_Y classification provided herein may serve as a placeholder. In an actual deployment scenario, the new DCI format may be assigned any appropriate number or label. In addition, the exemplary embodiments are not required to use a dedicated RNTI, an already defined RNTI or a future implementation of an RNTI may also be configured for DCI format 2_Y.

In some embodiments, instead of DCI format 2_Y, a different type of DCI format, DCI format 2_X, may be introduced that includes information related to a PSM operation. The DCI format 2_X may also be configured to include one or more PIFs. This may enable the network to support PRACH resource adaptation on a PSM cycle granularity. However, reference to DCI format 2_Y and DCI format 2_X is merely provided for illustrative purposes. An already defined DCI format may be enhanced to include the PIF or the PIF may be provided in any other appropriate manner.

In some embodiments, the UE 110 may implicitly determine the PRACH configuration that may be utilized for a RACH procedure during the PSM. For example, if a PSMI field in DCI is set to a first value (e.g., 0) indicating that the gNB 120A is to enter PSM, a predefined or default PRACH configuration may be activated. In one example, the default PRACH configuration may be the PRACH configuration with the lowest index in the prach-Configuration-List. In another example, the default PRACH configuration may be the PRACH configuration with a largest periodicity. In another example, the default PRACH configuration may be explicitly configured by a SIB (e.g., SIB1, etc.).

In 420, the UE 110 performs operations using the indicated PRACH resources. For example, the UE 110 may transmit an indicated PRACH preamble using the indicated PRACH resources.

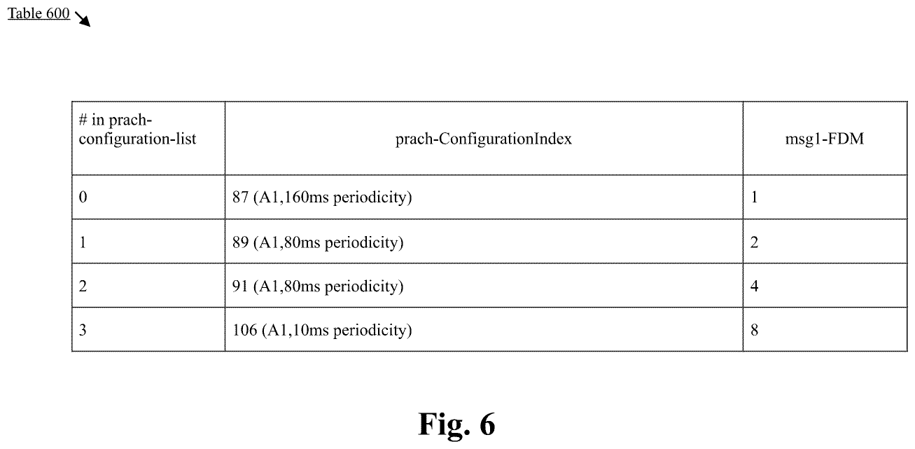

FIG. 6 shows a table 600 according to various exemplary embodiments. The table 600 shows an exemplary list comprising multiple pairs of prach-configurationIndex entries and msg1-FDM values each corresponding to an entry of the prach-configuration-list. The table 600 only shows a subset of the parameters that may be associated with a prach-ConfigurationIndex (e.g., index #, preamble format, periodicity). However, reference to these parameters is merely provided for illustrative purposes. Those skilled in the art will understand the type of parameters that may be associated with prach-ConfigurationIndex entries. In this example, four separate pairs are shown (e.g., number of entries in the prach-configuration-list (N)=4). However, reference to N=4 is merely provided for illustrative purposes the prach-configurationIndex may include any appropriate number of entries.

To provide an example within the context of the method 400, a 2-bit PIF field may be provided in DCI (e.g., DCI format 2_Y, DCI format 2_X, etc.) that indicates the selected PRACH configuration to be used by the UE 110 to adapt to the PSM. In another example, the PRACH configuration index associated with #0 in the prach-configuration-list may be activated by default when a PSMI field in the detected DCI is set to 0 because it has the largest periodicity. In another example, the PRACH configuration index associated with #4 in the prach-configuration-list may be activated by default when a PSMI field in the detected DCI is set to 0 because it is the lowest entry in the prach-configuration-list.

According to some aspects, the exemplary embodiments introduce techniques for dynamic adaptation of periodic TRS resource set. Those skilled in the art will understand that a TRS may be configured for downlink time and frequency tracking and each TRS resource set may consist of multiple periodic reference signals. The exemplary embodiments may enable the UE 110 to adapt to the TRS resource set that is to be used during PSM.

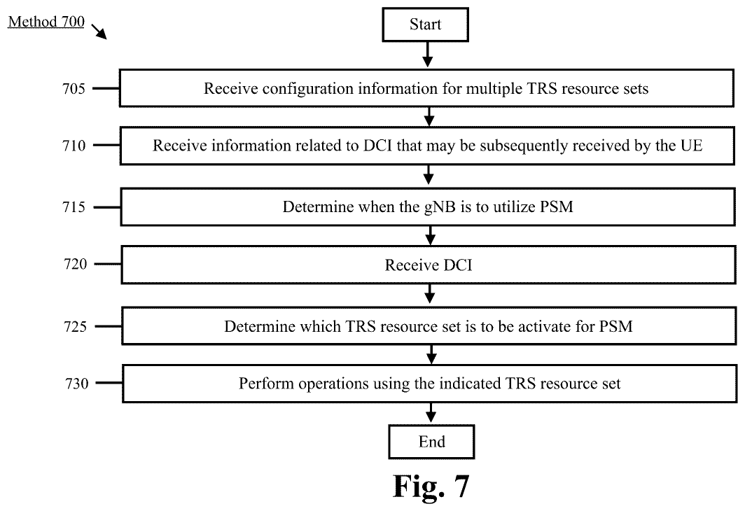

FIG. 7 shows a method 700 for dynamic adaptation of PRACH resources according to various exemplary embodiments. The method 700 is described from the perspective of the UE 110.

In 705, the UE 110 receives configuration information for multiple TRS resource sets. In this example, RRC connected mode UEs may receive the configuration information for the multiple TRS resource sets via dedicated RRC signaling. Throughout this description, one or more TRS resource sets provided via RRC signaling may be denoted as N_{TRS}^{C}. RRC idle mode UEs may receive the configuration information for the multiple TRS resource sets via SIB1. Throughout this description, one or more TRS resource sets provided via SIB1 may be denoted as N_{TRS}^{l}. However, the exemplary embodiments are not required to provide this configuration information to the UE 110 via either RRC signaling or SIB. The exemplary embodiments may provide this type of configuration information to the UE 110 in any appropriate manner.

In 710, the UE 110 receives information related to DCI that may be subsequently received by the UE 110. The exemplary embodiments introduce two new types of DCI that may be utilized for dynamic adaptation of periodic TRS resource set. Throughout this description, one new DCI format may be referred to as “DCI format 2_W.” The other new DCI format may be referred to as “DCI format 2_Z.” However, reference to DCI format 2_W and DCI format 2_Z are merely provided for illustrative purposes, the 2_W and 2_Z classifications provided herein may serve as a placeholder. In an actual deployment scenario, the new DCI formats may be assigned any appropriate number or label.

In some embodiments, information related to the DCI format 2_W may be provided to the UE 110 in SIB1. For example, SIB1 may provide a dedicated RNTI to the UE 110 that may be used to CRC scramble the DCI format 2_W. In other embodiments, the dedicated RNTI may be hard encoded in 3GPP Specifications or provided to the UE 110 in any other appropriate manner. Subsequently, RRC idle mode UEs may process the DCI format 2_W using the dedicated RNTI.

In other embodiments, information related to the DCI format 2_Z may be provided to the UE 110 via dedicated RRC signaling. For example, one or more RRC signals may provide a dedicated RNTI to the UE 110 that may be used to CRC scramble the DCI format 2_Z. In other embodiments, the dedicated RNTI may provide be hard encoded in 3GPP Specifications or provided to the UE 110 in any other appropriate manner. The dedicated RNTI may be cell specific (e.g., RRC signaling) or group specific (e.g., predefined, hard encoded in 3GPP, etc.).

In addition, the information related to the DCI may further comprise a payload size of DCI format 2_W, a location in DCI format 2_W of a starting position of a TRS indication (TRSI) field for a serving cell, a search space set configuration for monitoring for DCI format 2_W, a payload size of DCI format 2_Z, a location in DCI format 2_Z of a location in DCI format 2_Z of a starting position of a TRSI field for a serving cell, a search space set configuration for monitoring for DCI format 2_Z, any combination thereof and/or any other appropriate type of information.

In 715, the UE 110 determines when the gNB 120A is to utilize PSM. For example, the UE 110 may receive a signal from the gNB 120A indicating that a particular PSM cycle or pattern is to be utilized by the gNB 120A. In another example, the UE 110 may implicitly determine that the gNB 120A has entered PSM.

In 720, the UE 110 receives DCI (e.g., DCI format 2_W, DCI format 2_Z, etc.). In 725, the UE 110 determines which TRS resource set is activated for PSM. For example, the DCI may indicate to the UE 110 which TRS resource set is activated for PSM. In 730, the UE 110 performs operations using the indicated TRS resource set. However, in some examples, none of the TRS resource sets may be activated.

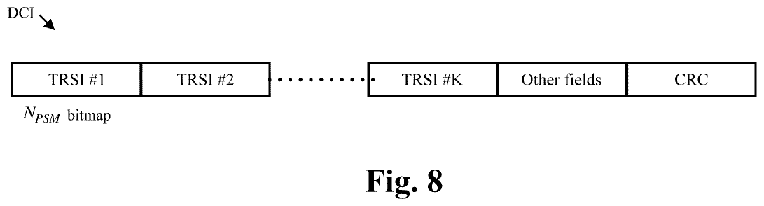

FIG. 8 shows an example of DCI 800 according to various exemplary embodiments. The exemplary DCI 800 may represent an example of DCI format 2_W or DCI format 2_Z.

The DCI 800 comprises multiple TRSI fields (e.g., TRSI #1, TRSI #2 . . . TRSI #K). The bitwidth of the TRSI field may be denoted as [log₂(M+1)] bits where M is the number of TRS resource sets previously configured by SIB or RRC signaling (e.g., 705). In some embodiments, a state of a TRSI field may be reserved to indicate that all configured TRS resource sets are deactivated. Accordingly, in some embodiments [log₂(M+1)] may utilized instead of [log₂(M)]. In addition, the exemplary DCI 800 may include other fields that may carry any other appropriate type of information and may be CRC scrambled.

In some embodiments, a 2-bit TRSI field may be utilized for TRS resource set adaptation. To provide an example, the UE 110 may be configured with three TRS resource sets via SIB or RRC signaling in 705 of the method 700. The DCI in 720 may dynamically indicate which TRS resource set may is to be utilized by the gNB 120A using a 2-bit TRSI field. A TRSI field set to a value of ‘01’ may indicate that a first TRS resource set is activated, a TRSI field set to a value of ‘10’ may indicate that a second TRS resource set is activated and a TRSI field set to a value of ‘11’ may indicate that a third TRS resource set is activated. As mentioned above, one TRS field value (e.g., ‘00’) may be utilized to indicate that all of the TRS resource sets are to be deactivated.

### Examples

In a first example, a method is performed by a user equipment (UE), comprising receiving a system information block (SIB) from a base station comprising a set of physical random access channel (PRACH) configurations for when the base station is to utilize a power saving mode and determining one of the PRACH configurations from the set of PRACH configurations is to be utilized for a random access channel (RACH) procedure.

In a second example, the method of the first example, wherein the SIB includes a first information element (IE) comprising a list of prach-configurationIndex IEs.

In a third example, the method of the second example, wherein the first IE further comprises a list of message 1 (msg1)-frequency division multiplexing (FDM) IEs.

In a fourth example, the method of the first example, further comprising receiving downlink control information (DCI), the DCI indicating which PRACH configuration has been selected by the base station for the power saving mode.

In a fifth example, the method of the fourth example, wherein the DCI comprises a PRACH configuration indication field (PIF) configured to dynamically indicate one PRACH configuration from the set of PRACH configurations.

In a sixth example, the method of the fifth example, wherein a bitwidth of the PIF is based on a number of entries in a prach-Configuration-list parameter provided in the SIB.

In a seventh example, the method of the fourth example, wherein the DCI comprises a power saving mode indicator (PSMI) set to a first value, the first value indicating that a default PRACH configuration is to be utilized for power saving mode.

In an eighth example, the method of the seventh example, wherein the default PRACH configuration is a PRACH configuration from the set of PRACH configurations with a lowest index in a prach-Configuration-list parameter provided in the SIB.

In a ninth example, the method of the seventh example, wherein the default PRACH configuration is a PRACH configuration from the set of PRACH configurations with a largest periodicity.

In a tenth example, the method of the seventh example, wherein the default PRACH configuration is explicitly indicated in the SIB.

In an eleventh example, a processor configured to perform any of the methods of the first through tenth examples.

In a twelfth example, a user equipment (UE) comprising a transceiver configured to communicate with a network and a processor communicatively coupled to the transceiver and configured to perform any of the methods of the first through tenth examples.

In a thirteenth example, a method is performed by a base station, comprising transmitting a system information block (SIB) comprising a set of physical random access channel (PRACH) configurations for when the base station is to utilize a power saving mode and transmitting downlink control information (DCI) to a user equipment (UE), the DCI indicating one PRACH configuration from the set of PRACH configurations is to be utilized for a random access channel (RACH) procedure.

In a fourteenth example, the method of the thirteenth example, wherein the SIB includes a first information element (IE) comprising a list of prach-configurationIndex IEs.

In a fifteenth example, the method of the fourteenth example, wherein the first IE further comprises a list of message 1 (msg1)-frequency division multiplexing (FDM) IEs.

In a sixteenth example, the method of the thirteenth example, wherein the DCI comprises a PRACH configuration indicator field (PIF) configured to dynamically indicate one PRACH configuration from the set of PRACH configurations.

In a seventeenth example, the method of the sixteenth example, wherein a bitwidth of the PIF is based on a number of entries in a prach-Configuration-list parameter provided in the SIB.

In an eighteenth example, the method of the thirteenth example, wherein the DCI comprises a power saving mode indicator (PSMI) set to a first value, the first value indicating that a default PRACH configuration is to be utilized for power saving mode.

In a nineteenth example, the method of the eighteenth example, wherein the default PRACH configuration is a PRACH configuration from the set of PRACH configurations with a lowest index in a prach-Configuration-list parameter provided in the SIB.

In a twentieth example, the method of the eighteenth example, wherein the default PRACH configuration is a PRACH configuration from the set of PRACH configurations with a largest periodicity.

In a twenty first example, the method of the eighteenth example, wherein the default PRACH configuration is explicitly indicated in the SIB.

In a twenty second example, a processor configured to perform any of the methods of the thirteenth through twenty first examples.

In twenty third example, a base station comprising a transceiver configured to communicate with a user equipment (UE) and a processor communicatively coupled to the transceiver and configured to perform any of the methods of the thirteenth through twenty first examples.

In a twenty fourth example, a method is performed by a user equipment (UE), comprising receiving a signal from a base station comprising multiple tracking reference signal (TRS) resource sets for when the base station is to utilize a power saving mode and receiving downlink control information (DCI) indicating whether zero or more of the multiple TRS resources sets are to be activated for the power saving mode.

In a twenty fifth example, the method of the twenty fourth example, wherein the signal is a system information block (SIB).

In a twenty sixth example, the method of the twenty fourth example, wherein the signal is provided by dedicated radio resource control (RRC) signaling.

In a twenty seventh example, the method of the twenty fourth example, wherein the signal further comprises a payload size of the DCI.

In a twenty eighth example, the method of the twenty fourth example, wherein the signal further comprises a starting location of a TRS indicator (TRSI) field within the DCI associated with a serving cell for the UE.

In a twenty ninth example, the method of the twenty fourth example, wherein the signal further comprises a search space set configuration for monitoring physical downlink control channel (PDCCH) to detect the DCI.

In a thirtieth example, the method of the twenty fourth example, further comprising receiving a dedicated radio network temporary identifier (RNTI) for the DCI.

In a thirty first example, the method of the twenty fourth example, wherein the dedicated RNTI is cell specific.

In a thirty second example, the method of the twenty fourth example, further comprising receiving a dedicated radio network temporary identifier (RNTI) for the DCI, wherein the dedicated RNTI is group specific and provided to the UE via dedicated radio resource control (RRC) signaling.

In a thirty third example, the method of the twenty fourth example, wherein the DCI comprises one or more TRS indicator fields configured to dynamically indicate whether one of the multiple TRS resource sets selected by the base station.

In a thirty fourth example, the method of the thirty third example, wherein a number of bits for a first TRS indicator field is based on at least a quantity of the multiple TRS resource sets.

In a thirty fifth example, the method of the thirty fourth example, wherein the number of bits for the first TRS indicator field is further based on the quantity of the multiple TRS resource sets plus an additional bit configured to indicate that all of the multiple TRS resource sets are to be deactivated.

In a thirty sixth example, the method of the thirty third example, further comprising, when the DCI indicates that one of the multiple TRS resource sets has been selected by the base station, a value in a first TRS indicator field indicate a specific one of the multiple TRS resource sets.

In a thirty seventh example, the method of the thirty third example, wherein a TRS indicator field of the DCI contains a value configured to indicate that the multiple TRS resources sets are to be deactivated for PSM.

In a thirty eighth example, a processor configured to perform any of the methods of the twenty fourth through thirty seventh examples.

In a thirty ninth example, a user equipment (UE) comprising a transceiver configured to communicate with a network and a processor communicatively coupled to the transceiver and configured to perform any of the methods of the twenty fourth through thirty seventh examples.

In a fortieth example, a method is performed by a base station, comprising transmitting a signal to a user equipment (UE) comprising multiple tracking reference signal (TRS) resource sets for when the base station is to utilize a power saving mode and transmitting downlink control information (DCI) indicating whether zero or more of the multiple TRS resources sets are to be activated for the power saving mode.

In a forty first example, the method of the fortieth example, wherein the signal is a system information block (SIB).

In a forty second example, the method of the fortieth example, wherein the signal is provided by dedicated radio resource control (RRC) signaling.

In a forty third example, the method of the fortieth example, wherein the signal further comprises a payload size of the DCI.

In a forty fourth example, the method of the fortieth example, wherein the signal further comprises a starting location of a TRS indicator (TRSI) within the DCI associated with a serving cell for the UE.

In a forty fifth example, the method of the fortieth example, wherein the signal further comprises a search space set configuration for monitoring physical downlink control channel (PDCCH) to detect the DCI.

In a forty sixth example, the method of the fortieth example, further comprising transmitting a dedicated radio network temporary identifier (RNTI) for the DCI to the UE, wherein the dedicated RNTI is group specific and provided to the UE via dedicated radio resource control (RRC) signaling.

In a forty seventh example, the method of the fortieth example, wherein the DCI comprises one or more TRS indicator fields configured to dynamically indicate whether one of the multiple TRS resource sets selected by the base station.

In a forty eighth example, the method of the fortieth example, wherein a number of bits for a first TRS indicator field is based on at least a quantity of the multiple TRS resource sets.

In a forty ninth example, the method of the forty eighth example, wherein the number of bits for the first TRS indicator field is further based on the quantity of the multiple TRS resource sets plus an additional bit configured to indicate that all of the multiple TRS resource sets are to be deactivated.

In a fiftieth example, the method of the forty eighth example, further comprising, when the DCI indicates that one of the multiple TRS resource sets has been selected by the base station, a value in a first TRS indicator field indicates a specific one of the multiple TRS resource sets.

In a fifty first example, the method of the fiftieth example, wherein a first TRS indicator field of the DCI contains a value configured to indicate that the multiple TRS resources sets are to be deactivated for PSM.

In a fifty second example, a processor configured to perform any of the methods of the fortieth through fifty first examples.

In fifty third example, a base station comprising a transceiver configured to communicate with a user equipment (UE) and a processor communicatively coupled to the transceiver and configured to perform any of the methods of the fortieth through fifty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signaling received from a base station, a system information block (SIB) comprising a set of physical random access channel (PRACH) configurations for when the base station is to utilize a power saving mode; and
determine one of the PRACH configurations from the set of PRACH configurations is to be utilized for a random access channel (RACH) procedure.

2. The apparatus of claim 1, wherein the SIB includes a first information element (IE) comprising a list of prach-configurationIndex IEs.

3. The apparatus of claim 2, wherein the first IE further comprises a list of message 1 (msg1)-frequency division multiplexing (FDM) IEs.

4. The apparatus of claim 1, wherein the processing circuitry is further configured to:
decode, based on signaling received from the base station, downlink control information (DCI), the DCI indicating which PRACH configuration has been selected by the base station for the power saving mode.

5. The apparatus of claim 4, wherein the DCI comprises a PRACH configuration indication field (PIF) configured to dynamically indicate one PRACH configuration from the set of PRACH configurations.

6. The apparatus of claim 5, wherein a bitwidth of the PIF is based on a number of entries in a prach-Configuration-list parameter provided in the SIB.

7. The apparatus of claim 4, wherein the DCI comprises a power saving mode indicator (PSMI) set to a first value, the first value indicating that a default PRACH configuration is to be utilized for power saving mode.

8. The apparatus of claim 7, wherein the default PRACH configuration is a PRACH configuration from the set of PRACH configurations with a lowest index in a prach-Configuration-list parameter provided in the SIB.

9. The apparatus of claim 7, wherein the default PRACH configuration is a PRACH configuration from the set of PRACH configurations with a largest periodicity.

10. The apparatus of claim 7, wherein the default PRACH configuration is explicitly indicated in the SIB.

11. An apparatus of a base station, the apparatus comprising processing circuitry configured to:
configure transceiver circuitry to transmit a system information block (SIB) comprising a set of physical random access channel (PRACH) configurations for when the base station is to utilize a power saving mode; and
configure transceiver circuitry to transmit downlink control information (DCI) to a user equipment (UE), the DCI indicating one PRACH configuration from the set of PRACH configurations is to be utilized for a random access channel (RACH) procedure.

12. The apparatus of claim 11, wherein the SIB includes a first information element (IE) comprising a list of prach-configurationIndex IEs.

13. The apparatus of claim 12, wherein the first IE further comprises a list of message 1 (msg1)-frequency division multiplexing (FDM) IEs.

14. The apparatus of claim 11, wherein the DCI comprises a PRACH configuration indicator field (PIF) configured to dynamically indicate one PRACH configuration from the set of PRACH configurations.

15. The apparatus of claim 14, wherein a bitwidth of the PIF is based on a number of entries in a prach-Configuration-list parameter provided in the SIB.

16. The apparatus of claim 11, wherein the DCI comprises a power saving mode indicator (PSMI) set to a first value, the first value indicating that a default PRACH configuration is to be utilized for power saving mode.

17. The apparatus of claim 16, wherein the default PRACH configuration is a PRACH configuration from the set of PRACH configurations with a lowest index in a prach-Configuration-list parameter provided in the SIB.

18. The apparatus of claim 16, wherein the default PRACH configuration is a PRACH configuration from the set of PRACH configurations with a largest periodicity.

19. The apparatus of claim 16, wherein the default PRACH configuration is explicitly indicated in the SIB.

20. An apparatus of a user equipment (UE), the apparatus comprising processing circuitry configured to:
decode, from signaling received from a base station, a signal comprising multiple tracking reference signal (TRS) resource sets for when the base station is to utilize a power saving mode; and
decode, from signaling received from the base station, downlink control information (DCI) indicating whether zero or more of the multiple TRS resources sets are to be activated for the power saving mode.
